(19) United States
(12) Patent Application Publication
(10) Pub. No.: US 2026/0210735 A1
(43) Pub. Date: Jul. 23, 2026

(54) SINGLE (1X) SPEED VARIABLE RELUCTANCE RESOLVER

(71) Applicant: ZFENCODER, INC., IRVINE, CA (US)

(72) Inventor: Chun Soo PARK, IRVINE, CA (US)

(21) Appl. No.: 19/208,065

(22) Filed: May 14, 2025

Related U.S. Application Data
(63) Continuation-in-part of application No. 19/034,155, filed on Jan. 22, 2025.

(51) Int. Cl. G01D 5/20; H02K 1/14; H02K 11/225; H02K 24/00

(52) U.S. Cl. CPC G01D 5/204; H02K 1/14; H02K 11/225; H02K 24/00; G01D 2205/774

(57) ABSTRACT

In a 1X speed 2N-phase VR resolver, 2N coil-poles are evenly distributed around the stator, N being an integer not smaller than three. A primary coil and sine and cosine signal sensing coils are wound at each coil-pole. All primary coils are wound with the same number of turns, with their winding polarities alternating across the coil-poles. The number of turns and winding polarities for the sine and cosine signal sensing coils at the coil-pole position n (1≤n≤2N) are determined by the sine and cosine synthesis coefficients at position n of the 2N-phase cosine-ZF transform. The coil turns ratios between the sine and cosine signal sensing coils relative to the primary coil are determined by the absolute values of the coefficients, whereas the winding polarities are dictated by signs of the synthesis coefficients and directions of the corresponding primary coils. Considering the sensitivity to misalignment and eccentricity associated with a 1X sinusoidal rotor lobe, a 1X quasi-square-waveform rotor lobe provides a more practical and advantageous alternative.

### CROSS-REFERENCE TO RELATED APPLICATION(S)

This application is a continuation-in-part of U.S. patent application Ser. No. 19/034,155, filed on Jan. 22, 2025, the entire content of which is hereby incorporated by reference.

### BACKGROUND OF THE INVENTION

### 1. Field of the Invention

The claimed subject matter relates to a resolver apparatus-more specifically, to a single (1X) speed variable reluctance (VR) resolver apparatus—that obtains the absolute angle of circularly moving objects.

### 2. Description of Related Art

VR resolvers have been widely used in motion control applications due to their robust position-sensing capabilities in harsh environments. Resolvers comprise a stator and a rotor, which typically produce sensed sine and cosine signals. The rotated angle (θ) of the target sensing element is calculated by taking the arctangent between the sensed sine and cosine signals.

VR resolvers have a simple architecture: all coils-a primary coil (excitation coil) and secondary coils—are wound exclusively on the stator. Secondary coils are sensing coils that consist of a sine signal sensing coil and a cosine signal sensing coil. However, achieving a 1X speed VR resolver capable of generating a single cycle of electrical signals on the stator's sensing coils for each full mechanical rotation of the rotor is challenging. This is primarily due to the well-known issue of the sensed sine signal's zero-crossing point (at 180 electrical degrees) being undefined or “floating,” as described in the reference [1](i.e., “Synchro and Resolver Engineering Handbook,” 2004, Moog Components Group Inc. MSG90020, 1213 N. Main Street, Blacksburg, VA 24060-3127, www.moog.com).

U.S. application Ser. No. 19/034,155 discloses a unified design principle for VR resolvers applicable to 1X speed with 2N number of coil-poles on the stator for cases in which Nis an odd integer greater than or equal to three. It is disclosed that the number of turns and winding polarities for secondary coils are determined by synthesis coefficients of an N-phase zero-force (ZF) transform, respectively. Additionally, this type of resolver is called an N-phase ZF VR resolver.

This invention presents a unified design principle for a 1X speed 2N-phase ZF VR resolver featuring 2N coil poles on the stator, applicable to both odd and even values of N.

### SUMMARY OF THE INVENTION

The present invention has been made in view of the aforementioned background, and it discloses a 1X speed 2N-phase ZF VR resolver when N is an integer greater than or equal to three.

In a general aspect, the invention provides a 1X speed 2N-phase ZF VR resolver apparatus including a stator and a rotor, where Nis an integer greater than or equal to three. The stator includes 2N coil-poles positioned at equal intervals around the inside of the stator body. At each of the 2N coil-poles, three types of coils are wound: a primary coil, a sine signal sensing coil, and a cosine signal sensing coil.

An 2N-phase cosine-ZF transform is introduced to explain the design principles of such a 1X speed 2N-phase VR resolver.

All primary coils are wound with an equal number of turns, with their winding directions alternating between clock-wise (CW) and counter clock-wise (CCW) across the 2N coil-poles. The number of turns and winding polarities for the secondary sensing coils are determined by the synthesis coefficients of the 2N-phase cosine-ZF transform.

Specifically, the coil turns ratios of the sine signal sensing and cosine signal sensing coils relative to the primary coil are determined by the absolute values of the corresponding sine synthesis and cosine synthesis coefficients of the 2N-phase cosine-ZF transform, respectively. The winding polarities of the sine signal sensing and cosine signal sensing coils are determined by the signs of the corresponding sine synthesis and cosine synthesis coefficients of the 2N-phase cosine-ZF transform, respectively. At coil-pole positions where the primary coils are wound in the CCW direction, the secondary coils must have a CCW winding direction to take a positive polarity as the sensing polarity follows the primary coil winding direction on the pole.

The sine and cosine synthesis are done with summing of all sine coils which wound on ZF 2N-phase coefficients by serial connection, and all cosine coils by serial connection.

The rotor includes a lobe that defines one electrical period over one mechanical turn of the rotor. Considering the sensitivity to misalignment and eccentricity in using a 1X speed rotor lobe with sinusoidal saliencies, a 1X speed rotor lobe with quasi-square waveform saliencies can be used advantageously. The resolver output signal error observed by the rotor lobe with quasi-square waveform saliencies can be compensated for at a later stage. However, in 2N-phase ZF VR resolver, when N is approximately 9 or more, the accuracy required in typical industrial applications can be achieved without the need for compensation.

One or more of the above-disclosed embodiments in addition to certain alternatives are provided in further detail below with reference to the attached figures. The claimed subject matter is not, however, limited to any particular embodiment disclosed.

### BRIEF DESCRIPTION OF THE DRAWINGS

Embodiments of the claimed subject matter are understood by referring to the figures in the attached drawings, as provided below.

FIG. 1 illustrates a 1X speed 5-phase ZF VR resolver.

FIG. 2 shows a block diagram of a balance-wired and double-wound 6-phase VR resolver, wherein secondary cosine signal sensing coils are wound and a 1X speed rotor with a single lobe is installed.

FIG. 3 illustrates a 1X speed 12-phase ZF VR resolver according to an embodiment of the present invention, wherein a 1X speed rotor with a single lobe is installed.

FIG. 4A illustrates a 1X speed quasi-square-waveform rotor lobe installed on 10-phase ZF VR resolver

FIG. 4B illustrates an expected envelope of quasi-square waveform displacement signal by the quasi-square-waveform rotor lobe.

FIG. 4C shows a Lissajous graph of two-phase orthogonal displacement signals on 10-phase ZF VR resolver with a quasi-square-waveform rotor lobe, compared to the Lissajous graph of ideal two-phase orthogonal signals.

Features, elements, and aspects that are referenced by the same numerals in different figures represent the same, equivalent, or similar features, elements, or aspects, in accordance with one or more embodiments.

### DETAILED DESCRIPTION OF THE INVENTION

In the following, numerous specific details are set forth to provide a thorough description of various embodiments of the claimed subject matter. Certain embodiments may be practiced without these specific details or with some variations in detail. In some instances, certain features are described in less detail so as not to obscure other aspects of the disclosed embodiments. The level of detail associated with each of the elements or features should not be construed to qualify the novelty or importance of one feature over the others.

U.S. application Ser. No. 19/034,155 addresses N-phase ZF VR resolvers when N is an odd integer greater than or equal to three. The coil-poles configuration on the stator of the N-phase ZF VR resolver is balance-wired, which is presented in U.S. Pat. No. 11,143,525B1.

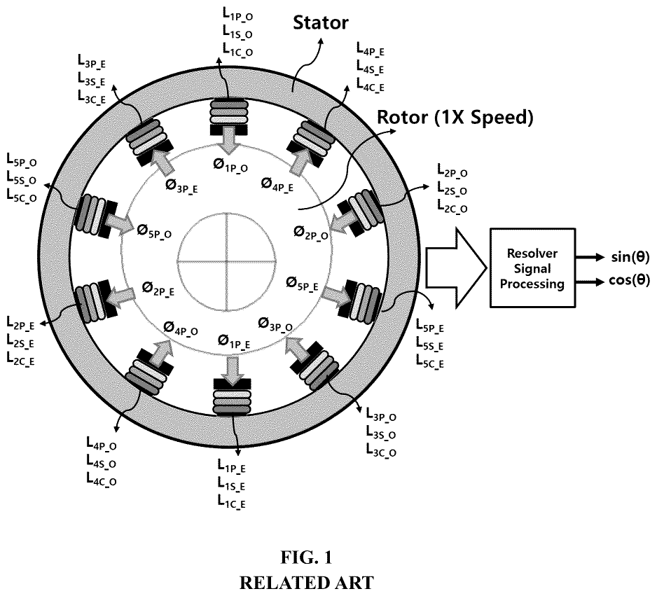

In the balance-wired configuration, there are 2N coil-poles on the stator for an N-phase ZF VR resolver. These coil-poles are grouped into N pairs. Each pair consists of an odd coil-pole and its matching even coil-pole positioned symmetrically 180 degrees apart. U.S. application Ser. No. 19/034,155 addresses that all primary coils are wound with an equal number of turns with the winding direction alternating across the 2N coil-poles, beginning with the first pole. Consequently, the primary coils at odd-numbered coil-pole positions are wound in a CW direction, whereas those at even-numbered coil-pole positions are wound in a CCW direction. The number of turns and winding polarities for the sine signal sensing and cosine signal sensing coils are determined by the sine synthesis and cosine synthesis coefficients of an N-phase ZF transform, respectively. FIG. 1 illustrates a 1X speed 5-phase ZF VR resolver presented in U.S. application Ser. No. 19/034,155 when Nis an odd number.

However, considering 2N equally spaced coil-poles on the stator, the 2N coil-poles are already naturally arranged into N coil-pole pairs before being divided into odd and even coil-poles. Therefore, to establish a unified design principle for a 1X ZF VR resolver applied to any even number (2N) of coil poles on the stator, a cosine-ZF transform is introduced as follows.

U.S. Pat. No. 11,221,237B2 and the reference [2](i.e., Chris. K. Park, Inhyuk Lee, and Chun Soo Park, “Multiphase Sensor Signal Processing,” IEEE Sens. Lett., vol. 6, no. 2, Jun. 2022, Art. No. 2500504) provide a detailed explanation of the ZF transform, wherein signals sensed by position sensors are regarded as sine waveforms. In other words, in driving the ZF transform that optimally converts N-phase delayed signals sensed from N sensors into two-phase orthogonal signals, the sensed N-phase delayed signals are assumed to be sine waveforms. Thus, this ZF transform can be termed a sine-ZF transform as the sensed N-phase delayed signals are regarded as sine waveforms.

Since a cosine signal is simply a sine signal delayed by 90 degrees, the sensed N-phase delayed signals can also be considered cosine waveforms. In driving the ZF transform, the cosine-ZF transform assumes that the sensed N-phase delayed signals are N-phase delayed cosine waveforms.

When the N-phase delayed signals sensed by N number of sensors are considered cosine waveforms, the N-phase delayed cosine waveforms are shifted by

$$\frac{360 °}{N}$$

relative to each other as the rotor rotates. Let yₙ(θ) be the sensed cosine waveform on the nth sensor (1≤n≤N). Then, the phase of yₙ(θ) is,

$$\frac{360 °}{N} ( n - 1 ) ,$$

and yₙ(θ) can be expressed as follows:

$${y}_{n} ( θ ) = cos ( θ - \frac{2 π}{N} \times ( n - 1 ) ) , 1 \leq n \leq N \qquad EQ . ( 1 )$$

EQ. 1 can be decomposed into sin 0 and cos 0 by applying the cosine addition formula, cos(a+b)=cos(a)*cos(b)−sin(a)*sin(b).

$${y}_{n} ( θ ) = cos ( θ ) * cos ( \frac{2 π}{N} \times ( n - 1 ) ) + sin ( θ ) * sin ( \frac{2 π}{N} \times ( n - 1 ) ) \qquad EQ . ( 2 )$$

EQ. (2) can be rewritten in a matrix form for all N-phase delayed cosine waveforms of yₙ(θ), 1≤n≤N.

$$[ \begin{matrix}{y}_{1} ( θ ) \\ {y}_{2} ( θ ) \\ {y}_{3} ( θ ) \\ ⋮ \\ ⋮ \\ {y}_{N} ( θ )\end{matrix} ] = [ \begin{matrix}cos ( 0 ) & sin ( 0 ) \\ cos ( \frac{2 π}{N} \times 1 ) & sin ( \frac{2 π}{N} \times 1 ) \\ cos ( \frac{2 π}{N} \times 2 ) & sin ( \frac{2 π}{N} \times 2 ) \\ ⋮ & \\ ⋮ & \\ cos ( \frac{2 π}{N} \times ( N - 1 ) ) & sin ( \frac{2 π}{N} \times ( N - 1 ) )\end{matrix} ] * [ \begin{matrix}cos ( θ ) \\ sin ( θ )\end{matrix} ] = H * [ \begin{matrix}cos ( θ ) \\ sin ( θ )\end{matrix} ] \qquad EQ . ( 3 )$$

where H is an N by 2 matrix that decomposes N-phase delayed cosine waveforms into two-phase orthogonal signals.

Therefore, by solving the system of linear equations of EQ. (3), the conversion of N-phase delayed cosine waveforms into two-phase orthogonal signals is found. In solving the equations, the inverse of His calculated. His not a square matrix, but its pseudo-inverse (H⁺) exists and may have multiple solutions. Accordingly, the two-phase orthogonal signals are simply obtained by applying H⁺ to the N-phase delayed cosine waveforms as shown in EQ. (4).

$$x = [ \begin{matrix}cos ( θ ) \\ sin ( θ )\end{matrix} ] = {H}^{+} y \qquad EQ . ( 4 )$$

where y is an N by 1 vector representing the N-phase delayed cosine waveforms and x is a 2 by 1 vector that represents the corresponding two-phase orthogonal signals.

The EQ. (4), which converts N-phase cosine signals into two-phase orthogonal signals using H⁺ matrix, is referred to as the cosine-ZF transform.

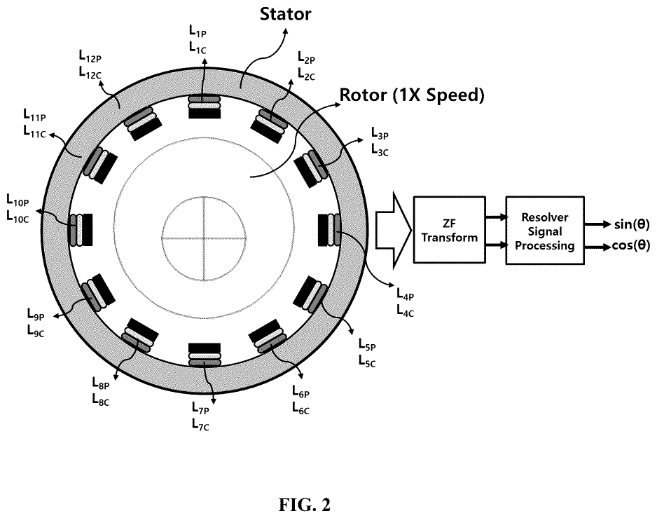

From this point forward, a 1X speed ZF VR resolver applied to an even-numbered (2N) coil-poles in the balance-wired configuration is referred to as a 1X speed 2N-phase ZF VR resolver. As an 2N-phase VR resolver, FIG. 2 illustrates a balanced-wired and double-wound 12-phase (2N=12) VR resolver featuring 12 coil-poles on the stator. The six coil-poles (L₁, L₂, L₃, L₄, L₅, L₆) are regarded as odd coil-poles, and the remaining six coil-poles (L₇, L₈, L₉, L₁₀, L₁₁, L₁₂) are regarded as even coil-poles with a 1800 mechanical angle offset.

Each coil-pole is wound with a primary coil (L_{P}) and a secondary cosine signal sensing coil (L_{C}). The primary coils and cosine signal sensing coils are labeled with the subscripts “P” and “C,” respectively. When a carrier signal is applied to the primary coils, 2N-phase delayed cosine waveform signals are sensed from the 2N cosine signal sensing coils as the rotor rotates. As shown in FIG. 2, the sensed 2N-phase delayed cosine waveform signals undergo a ZF transform, specifically a 12-phase cosine-ZF transform, to produce two-phase orthogonal signals.

The matrix H⁺ for the 12-phase cosine-ZF transform signals is calculated as follows.

$${H}^{+} = [ \begin{matrix}{c}_{1} & {c}_{2} & {c}_{3} & {c}_{4} & {c}_{5} & {c}_{6} & {c}_{7} & {c}_{8} & {c}_{9} & {c}_{10} & {c}_{11} & {c}_{12} \\ {s}_{1} & {s}_{2} & {s}_{3} & {s}_{4} & {s}_{5} & {s}_{6} & {s}_{7} & {s}_{8} & {s}_{9} & {s}_{10} & {s}_{11} & {s}_{12}\end{matrix} ] \qquad EQ . ( 5 )$$

The set of coefficients (C₁, C₂, C₃, C₄, C₅, C₆, C₇, C₈, C₉, C₁₀, C₁₁,C₁₂) and (S₁, S₂, S₃, S₄, S₅, S₆, S₇, S₈, S₉, S₁₀, S₁₁, S₁₂) in H⁺ are referred to as cosine synthesis coefficients and sine synthesis coefficients of the 12-phase cosine-ZF transform, respectively.

When a carrier signal is applied to the primary coils (L_{1P}, L_{2P}, . . . , L_{11P}, L_{12P}), signals are induced on the cosine sensing coils (L_{1C}, L_{2C}, . . . , L_{11C}, L_{12C}). Let the induced signal voltages on the cosine sensing coils (L_{1C}, L_{2C}, . . . , L_{11C}, L_{12C}) be represented as (V₁, V₂ . . . , V₁₁, V₁₂), respectively. Then, voltages V_{sin(θ)} and V_{cos(θ)} of the two-phase orthogonal signals (sin(θ) and cos(θ)) can be obtained by EQ. (4) and as follows:

$${V}_{co s ( θ )} = {c}_{1} * {V}_{1} + {c}_{2} * {V}_{2} + {c}_{3} * {V}_{3} + {c}_{4} * {V}_{4} + {c}_{5} * {V}_{5} + {c}_{6} * {V}_{6} + {c}_{7} * {V}_{7} + {c}_{8} * {V}_{8} + {c}_{9} * {V}_{9} + {c}_{10} * {V}_{10} + {c}_{11} * {V}_{11} + {c}_{12} * {V}_{12} \qquad EQ . ( 6 )$$

$${V}_{si n ( θ )} = {s}_{1} * {V}_{1} + {s}_{2} * {V}_{2} + {s}_{3} * {V}_{3} + {s}_{4} * {V}_{4} + {s}_{5} * {V}_{5} + {s}_{6} * {V}_{6} + {s}_{7} * {V}_{7} + {s}_{8} * {V}_{8} + {s}_{9} * {V}_{9} + {s}_{10} * {V}_{10} + {s}_{11} * {V}_{11} + {s}_{12} * {V}_{12}$$

EQ. (6), the 12-phase cosine-ZF transform, represents the ZF transform shown in FIG. 2. As explained in U.S. Pat. No. 11,221,237B2, the ZF transform is a method for accurately obtaining two-phase orthogonal displacement signals from the 2N sequentially phase-delayed sinusoidal signals sensed by the stator's 2N coil-poles as the rotor rotates.

The rotational angle (θ) of the rotor is calculated by taking the arc tangent of the ratio between V_{sin(θ)} and V_{cos(θ)} after resolver signal processing.

Upon closer examination of EQ. (6), the functionality of the cosine-ZF transform can be integrated into the coil windings on the coil-poles. This is achieved by adding another secondary sine signal sensing coil to each coil-pole and configuring the windings of both the sine signal sensing coils and cosine signal sensing coils in accordance with EQ. (6).

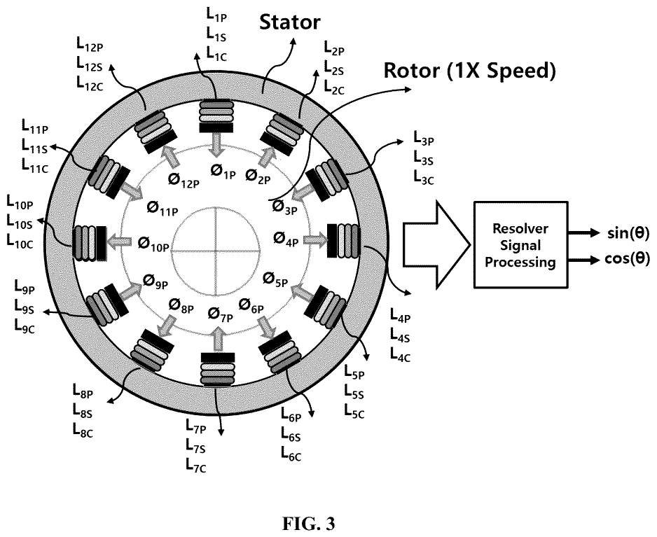

When the sine signal sensing coil is added to each coil-pole, all three types of coils—the primary, sine signal sensing, and cosine signal sensing coils—are wound at each coil—pole as illustrated in FIG. 3. This figure also shows the 1X speed rotor with a single lobe.

All primary coils are wound with the same number of turns, but their winding polarities alternate across the 2N coil-poles. In FIG. 3, the flux (Ø) direction of each primary coil is indicated by an arrow. The windings of the secondary coils follow the synthesis coefficients in EQ. (5). That is, the magnitude of each coefficient in EQ. (5) or EQ. (6) determines the coil turn ratio of the sine (or cosine) sensing coil to the primary coil, whereas the sign of the coefficient determines the winding polarity of the sine (or cosine) signal sensing coil at the corresponding coil-pole position. Thus, the absolute value of a coefficient in EQ. (6) represents the number of coil turns on the corresponding coil-pole position, with the positive (+) or negative (−) sign indicating the winding polarity.

Let the number of coil-winding turns of the primary coil be N, and the numbers of coil-winding turns for the sine signal sensing coils (L_{1S}, L_{2S}, . . . , L_{11S}, L_{12S}) be (N_{1S}, N_{2S}, . . . , N_{11S}, N_{12S}). Then, the coil turns ratios of the sine signal sensing coils to the primary coil are as follows:

$$( {N}_{1 S} , {N}_{2 S} , {N}_{3 S} , {N}_{4 S} , {N}_{5 S} , {N}_{6 S} , {N}_{7 S} , {N}_{8 S} , {N}_{9 S} , {N}_{10 S} , {N}_{11 S} , {N}_{12 S} ) / {N}_{P} = ( {s}_{1} , {s}_{2} , {s}_{3} , {s}_{4} , {s}_{5} , {s}_{6} , {s}_{7} , {s}_{8} , {s}_{9} , {s}_{10} , {s}_{11} , {s}_{12} ) \qquad EQ . ( 7 )$$

Likewise, let the numbers of coil-winding turns for the cosine signal sensing coils (L_{1C}, L_{2C}, . . . , L_{11C}, L_{12C}) be (N_{1C}, N_{2C}, . . . , N_{11C}, N_{12C}). Then, the coil turns ratios of the cosine signal sensing coils to the primary coil are as follows:

$$( {N}_{1 C} , {N}_{2 C} , {N}_{3 C} , {N}_{4 C} , {N}_{5 C} , {N}_{6 C} , {N}_{7 C} , {N}_{8 C} , {N}_{9 C} , {N}_{10 C} , {N}_{11 C} , {N}_{12 C} ) / {N}_{P} = ( {c}_{1} , {c}_{2} , {c}_{3} , {c}_{4} , {c}_{5} , {c}_{6} , {c}_{7} , {c}_{8} , {c}_{9} , {c}_{10} , {c}_{11} , {c}_{12} ) \qquad EQ . ( 8 )$$

When the synthesis coefficient is positive, the corresponding secondary coil at odd-numbered coil-pole position is wound in the CW direction, and when it is negative, the coil is wound in the CCW direction. However, since the primary coils at even-numbered coil-pole positions are wound in the CCW direction, the secondary coils at these positions must have their winding direction reversed to counteract the opposing flux direction of the primary coils. This ensures that the voltages induced in the secondary coils accurately correspond to the actual values of the synthesis coefficients in EQ (5) or EQ (6).

The preceding explanation pertains to the N=6 case. The 1X speed 12-phase ZF VR resolver is realized by determining the number of coil-winding turns and winding polarities based on the synthesis coefficients of the 12-phase cosine-ZF transform. The explanation for the 12-phase (N=6) ZF VR resolver applies equivalently not only when N is an even number but also when N is odd, where N is an integer greater than or equal to three.

In summary, 1X speed 2N-phase ZF VR resolvers are realized on 2N coil-poles on a stator positioned at equal intervals around the inside of the stator body. At each of the 2N coil—poles, a primary coil and secondary coils—i.e., sine signal sensing and cosine signal sensing coils—are wound. All primary coils are wound serially with an equal number of turns; however, the winding direction alternates across the 2N coil-poles, beginning with the first pole. The number of turns and winding polarities for the secondary coils are determined by the synthesis coefficients of the 2N-phase cosine-ZF transform.

The coil turns ratios of the sine signal sensing and cosine signal sensing coils relative to the primary coil at the coil-pole position n (1≤n≤2N) are determined by the absolute values of the corresponding sine synthesis and cosine synthesis coefficients at position n (1≤n≤2N) of the 2N-phase cosine-ZF transform, respectively. The winding polarities of the sine signal sensing and cosine signal sensing coils at the coil-pole position n (1≤n≤2N) are determined by the signs of corresponding sine synthesis and cosine synthesis coefficients at position n (1≤n≤2N) of the 2N-phase cosine-ZF transform, respectively. The winding direction of the secondary coil located at a position where the primary coil is wound in the CCW direction must have a CCW winding direction to take a positive polarity if the signs of the corresponding synthesis coefficients are positive(+).

Considering the transfer ratio of resolvers—defined as the ratio of output voltage to input voltage when the rotor is in a specific reference position (typically the position of maximum inductive coupling)—the number of coil turns in the secondary sensing coils at coil poles can be proportionally increased in practical applications to achieve the desired transfer ratio.

### Rotor Lobe of Quasi-Square Waveform Saliencies

As the 1X rotor lobe saliencies directly affect the shape of resolver output signal, rotor lobe requires a sophisticated design and high precision manufacturing process in order to produce a precise sinusoidal signal. In practical applications, however, the 1X speed sinusoidal lobe shown in FIG. 3 is highly sensitive to mechanical errors in the rotor contour, stator, and coil winding, as well as any slight misalignment during installation.

U.S. Pat. No. 11,143,525B1 discloses the rotor lobe of quasi-square waveform saliencies (hereinafter referred to as “quasi-square-waveform rotor lobe”). The sensed displacement signals on the quasi-square-waveform rotor lobe are quasi-square waveform signals (or trapezoidal signals). When N phase-delayed displacement signals of quasi-square waveform signals are ZF transformed, the resultant two-phase orthogonal displacement signals are stair step signals, of which the Lissajous graph is the shape of a 2N-gon; an accurate position information is determined after compensating the error signal between the 2N-gon and the pure circle by a piece-wise linear approximation technique, which is known a priori.

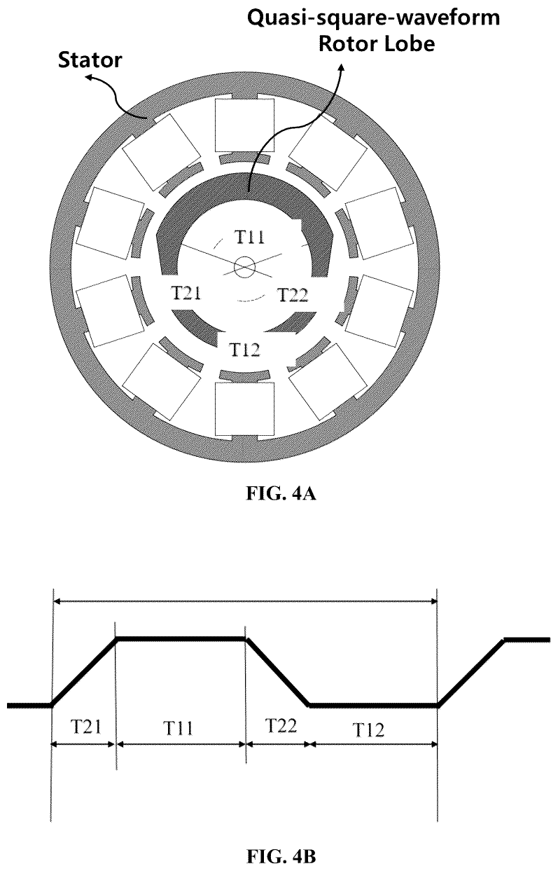

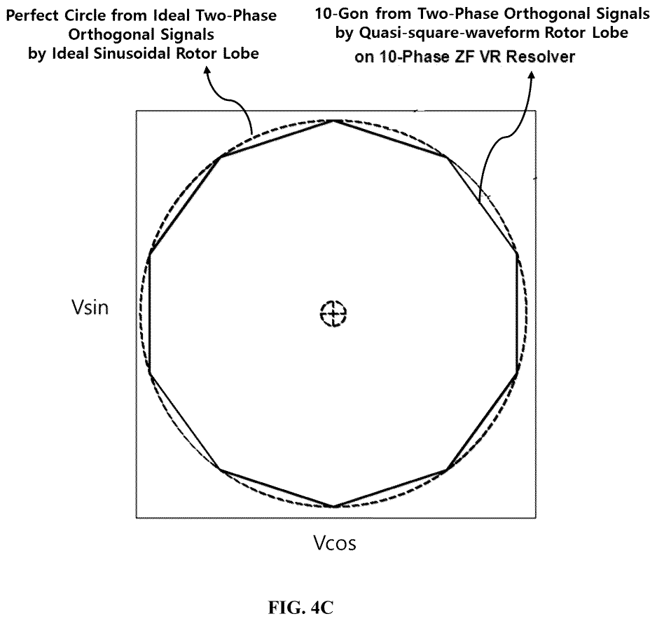

An exemplary quasi-square-waveform rotor lobe installed in 5-phase ZF VR resolver is shown in FIG. 4A. The rotor lobe circumference is largely divided into 2 sections as shown in FIG. 4A; a least varying airgap permeance section of T1 (arc shape) and a most varying airgap permeance section of T2 (slope shape). T1 can be divided into two sections, T11 and T12, of which radius is different from each other such that T11 has a larger radius than T12 from a rotor center. Therefore, signal amplitude induced at T11 is bigger than the one at T12. T2 can be divided into two sections, T21 and T22, both of which slope is identical, but with an opposite direction. T21 and T22 is symmetrically located at the opposite side. Since T21 and T22 airgap permeance varies quickly, the signal induced at T21 and T22 changes fast at the opposite direction.

The resultant quasi-square (or trapezoidal) waveform signal is shown in FIG. 4B. As the rotor rotates, the arc shaped section (T11 or T12) of the rotor lobe produces either a higher or lower level signal upon the two different radii; T11 produces the higher level signal and T12 produces the lower level signal. The slope shaped section (T21 or T22) produces either a rising edge signal (T21) or falling edge signal (T22).

The signal sensed on a coil by the quasi-square-waveform rotor lobe is an AM modulated signal by an excitation signal carrier, but its envelope is a quasi-square (or trapezoidal) waveform signal as shown in FIG. 4B. Therefore, the 1X 10-phase ZF VR resolver equipped with the quasi-square-waveform rotor lobe will generate two-phase orthogonal signals (sin(θ) and cos(θ)) from the successively 360 phase-delayed displacement signals that sensed on 10 cosine signal and sine signal sensing coils, of which coil-windings are based on the ZF synthesis coefficients from 10-phase cosine-ZF transform.

To check the orthogonality of the two-phase orthogonal signals (sin(θ) and cos(θ)), the Lissajous graph is drawn in FIG. 4C, which shows that the outline of the Lissajous graph is a 10-gon. By fine tuning the slopes of T21 and T22, the resulting Lissajous graph can approach a circumferential circle, which represents ideal orthogonality of the two-phase orthogonal signals. Further compensation processing can be made to improve the position detection accuracy in the two-phase orthogonal signals.

However, with an increased number of sensing phases (coil-poles), such as 18-phases ZF VR resolver, it is expected that the resolver can be used directly without compensation in typical applications. This is because its Lissajous graph forms an 18-gon, which more closely approximates a circular contour, thereby offering higher position accuracy compared to the 10-phase ZF VR resolver.

The conventional rotor lobe with sinusoidal saliencies generates a sinusoidal signal sensed on a coil-pole. A well-designed rotor lobe with sinusoidal saliencies can certainly generate a more accurate sinusoidal signal, resulting in improved position detection accuracy. However, given the manufacturing complexity of such a rotor lobe and the challenges in dealing with misalignment and eccentricity during installation, the quasi-square-waveform rotor lobe with simple lobe contour offers greater practical advantages.

The claimed subject matter has been described above with reference to one or more features or embodiments. Those skilled in the art will recognize, however, that changes and modifications may be made to these embodiments without departing from the scope of the claimed subject matter. These and various other adaptations and combinations of the embodiments disclosed are within the scope of the claimed subject matter as defined by the claims and their full scope of equivalents.

What is claimed is:

1. An 2N-phase variable reluctance (VR) resolver apparatus, N being an integer greater than or equal to three, the 2N-phase VR resolver apparatus comprising:
a stator comprising:
2N number of coil-poles that are positioned at equal intervals around inside of the stator; and
a primary coil and secondary coils that are wound at each of the 2N coil-poles,
wherein the secondary coils include a sine signal sensing coil and a cosine signal sensing coil, and all primary coils are wound with the same number of coil turns, with the winding direction alternating between clock-wise (CW) and counter clock-wise (CCW) across the 2N coil-poles, wherein the number of coil turns and winding polarities for the secondary coils are determined by synthesis coefficients of a 2N-phase cosine-zero-force (ZF) transform,
wherein coil turns ratios of the sine signal sensing and cosine signal sensing coils relative to the primary coil at coil-pole position n (1≤n≤2N) are determined by the absolute values of the corresponding sine synthesis and cosine synthesis coefficients at position n (1≤n≤2N) of the 2N-phase cosine-ZF transform, respectively,
wherein coil-winding polarities of the sine signal sensing and cosine signal sensing coils at coil-pole position n (1≤n≤2N) are determined by signs of the corresponding sine synthesis and cosine synthesis coefficients at position n (1≤n≤2N) of the 2N-phase cosine-ZF transform, respectively,
wherein the coil-winding polarities of the secondary coils at a coil-pole position where the primary coil is wound in the CCW direction have a CCW winding direction to take a positive polarity; and
a rotor comprising:
a lobe defining one electrical period on the stator over one mechanical turn of the rotor.

2. The 2N-phase variable reluctance (VR) resolver apparatus according to claim 1,
wherein the lobe is used for a quasi-square waveform signal generation, wherein a circumference of the lobe is divided into an arc shape section of a constant airgap and a slope shape section of a linearly varying airgap between the stator and the lobe,
wherein the arc shape section has two saliencies that are symmetrically located with different radii, while the slope shape section has two saliencies that are symmetrically located with the slope, but with opposite direction,
wherein as the lobe is displaced, the arc shape section generates one of a higher level signal or a lower level signal upon the two different radii, whereas the slope shape section generates either a rising edge or falling edge signal of the quasi-square waveform signal,
wherein sine and cosine signals of the two-phase orthogonal signals are sensed from the sine signal sensing coils and the cosine signal sensing coils on 2N coil-poles, respectively, and
wherein the lobe for the quasi-square waveform signal generation produces stair stepped sine and cosine signals, of which Lissajous graph is a shape of 2N-gon.
